(19) United States
(12) Patent Application Publication
(10) Pub. No.: US 2011/0081192 A1
(43) Pub. Date: Apr. 7, 2011

(54) Cone to Boom Interconnection

(75) Inventors: Ian Renilson, Dalgety Bay (GB); Ronald J. Brandau, Homer Glen, IL (US); Julian Stephens, Strafford upon Avon (GB)

(73) Assignee: ANDREW LLC, Hickory, IL (US)

(21) Appl. No.: 12/572,493

(22) Filed: Oct. 2, 2009

(51) Int. Cl. F16D 1/00

(52) U.S. Cl. 403/24

(57) ABSTRACT

A cone to boom interconnection, the cone provided with an annular mating groove of the cone dimensioned to receive a distal end of the boom. At least one retention groove and at least one gasket groove provided in the sidewall(s) of the mating groove. Alternatively, the gasket groove may be provided in a distal end of the boom. A gasket seated in the at least one gasket groove, sealing between the sidewall of the mating groove and the boom. A glue between the boom and the annular mating groove. The glue adhered to the boom as an annular retention lip within the at least one retention groove, whereby the cone is mechanically retained upon the boom.

### BACKGROUND

1. Field of the Invention

This invention relates to microwave reflector antennas. More particularly, the invention relates to an improved interconnection arrangement between a polymeric cone type sub-reflector and a supporting metallic boom waveguide of the reflector antenna.

2. Description of Related Art

Microwave reflector antennas with a feed arrangement comprising a polymeric cone type sub-reflector supported proximate a focal point of the reflector dish by a metallic boom waveguide provide improved electrical performance and significant manufacturing cost efficiencies compared to alternative reflector antenna subreflector/feed configurations. Exemplary of such feed arrangements is commonly owned U.S. Pat. No. 6,919,855 “Tuned Perturbation Cone Feed for Reflector Antenna” by Chris Hills, issued Jul. 19, 2005, hereby incorporated by reference in the entirety.

The cone to boom interconnection retains the sub-reflector cone at the desired position and/or orientation and also provides an environmental seal for the open end of the boom waveguide. The boom waveguide may be coupled directly to environmentally sensitive electrical equipment such as a transceiver. If the interconnection becomes compromised, the environmental seal protecting the transceiver from moisture, humidity and/or solids contamination/fouling may be broken.

Prior cone to boom interconnections may include an interference fit between the boom end and the cone, glue, and/or threads machined in the cone and/or boom. Threaded interconnections may require a significant number of additional manufacturing steps, increasing manufacturing costs. Also, threads may introduce undesired reflection points and/or impedance discontinuities for signals traveling along the interconnection surfaces.

Competition in the reflector antenna market has focused attention on improving long-term electrical performance and minimization of overall manufacturing costs. Therefore, it is an object of the invention to provide a cone to boom interconnection that overcomes deficiencies in the prior art.

### BRIEF DESCRIPTION OF THE DRAWINGS

The accompanying drawings, which are incorporated in and constitute a part of this specification, illustrate embodiments of the invention, where like reference numbers in the drawing figures refer to the same feature or element and may not be described in detail for every drawing figure in which they appear and, together with a general description of the invention given above, and the detailed description of the embodiments given below, serve to explain the principles of the invention.

FIG. 1 is a schematic isometric rear view of an exemplary cone and boom interconnection.

FIG. 2 is a schematic side view of FIG. 1.

FIG. 3 is a schematic cross section side view along line A-A of FIG. 2

FIG. 4 is a close-up view of area B of FIG. 3.

FIG. 5 is a schematic cross section view of an alternative embodiment.

FIG. 6 is a close-up view of area B of FIG. 5.

### DETAILED DESCRIPTION

The inventors have recognized that interference fit and/or glue interconnections between the cone and boom are subject to accelerated failure when exposed to extreme environmental conditions. The different adhesion properties and/or thermal expansion characteristics of the polymeric and metallic materials used to form the polymeric cone and metallic boom accelerates degradation of rigid glue interconnections and/or loosens interference fit connections as the interconnection is subjected to extreme temperature changes over time.

A cone to boom interconnection according to the invention accepts that the glue connection will not be rigid with respect to the polymeric material, instead relying upon the glue to securely adhere to the metal surface of the boom, forming a retaining lip in one or more retaining grooves where the glue is applied and/or accumulates during assembly. When cured, the retaining lip of glue maintains a secure connection with the metal material; the retaining lip keying between the retaining groove sidewalls to mechanically retain the cone upon the boom. A gasket, such as an o-ring, applied to a separate gasket groove provides a flexible environmental seal between the cone and the boom.

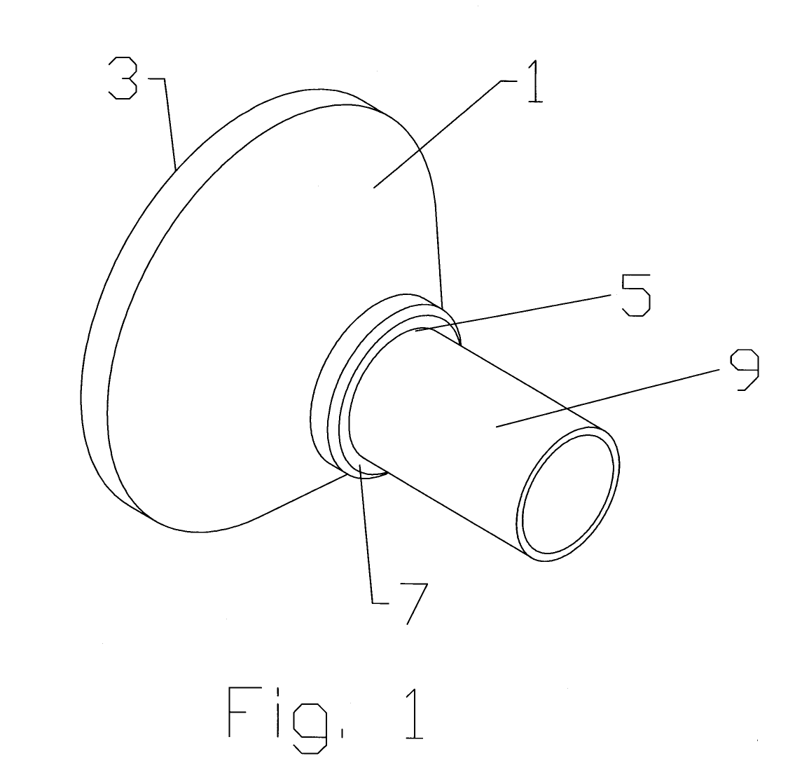

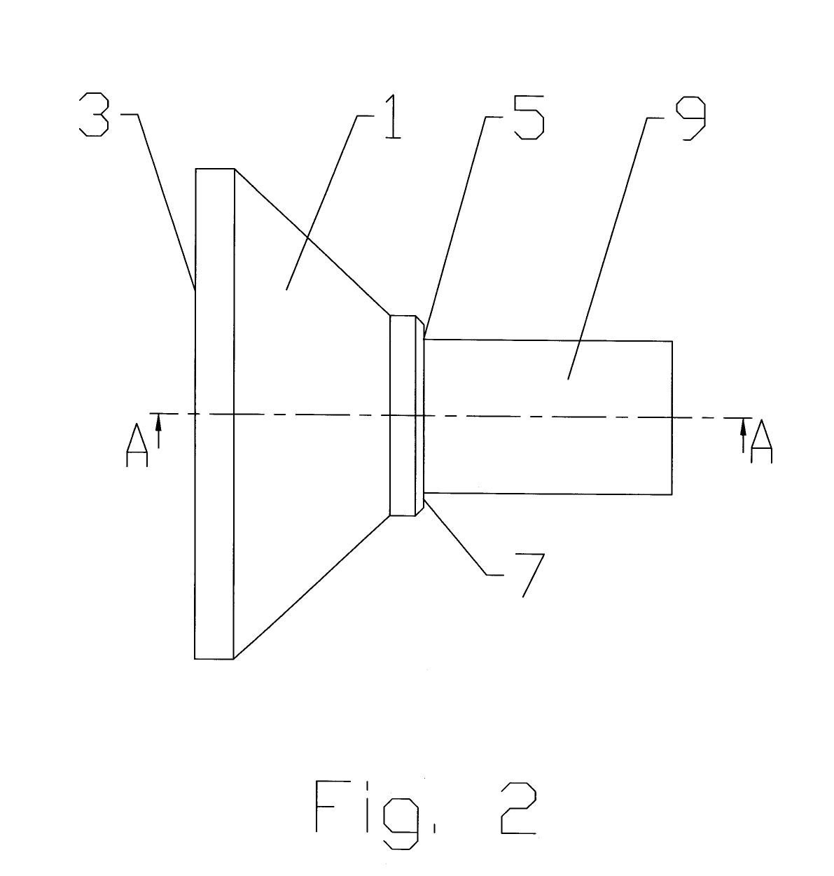

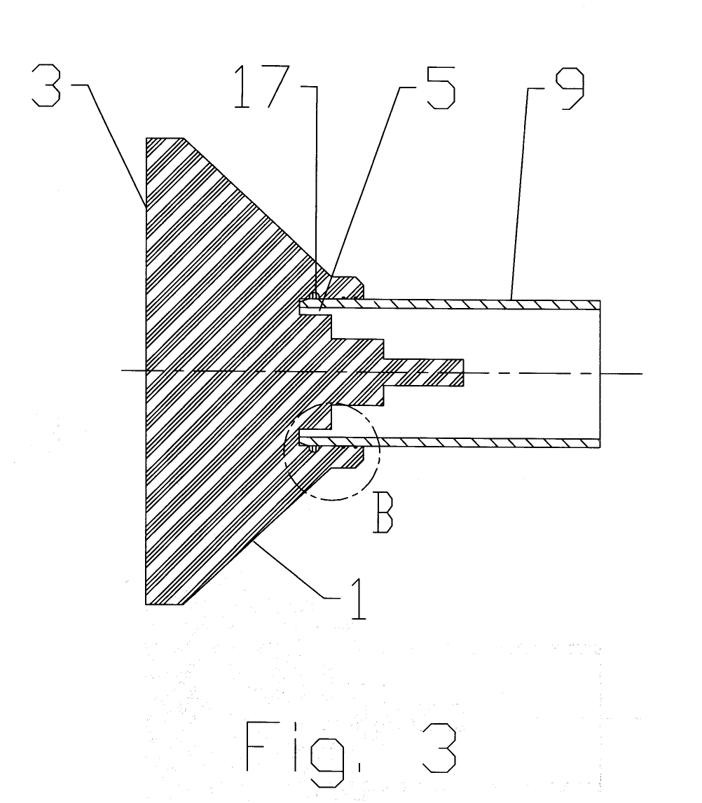

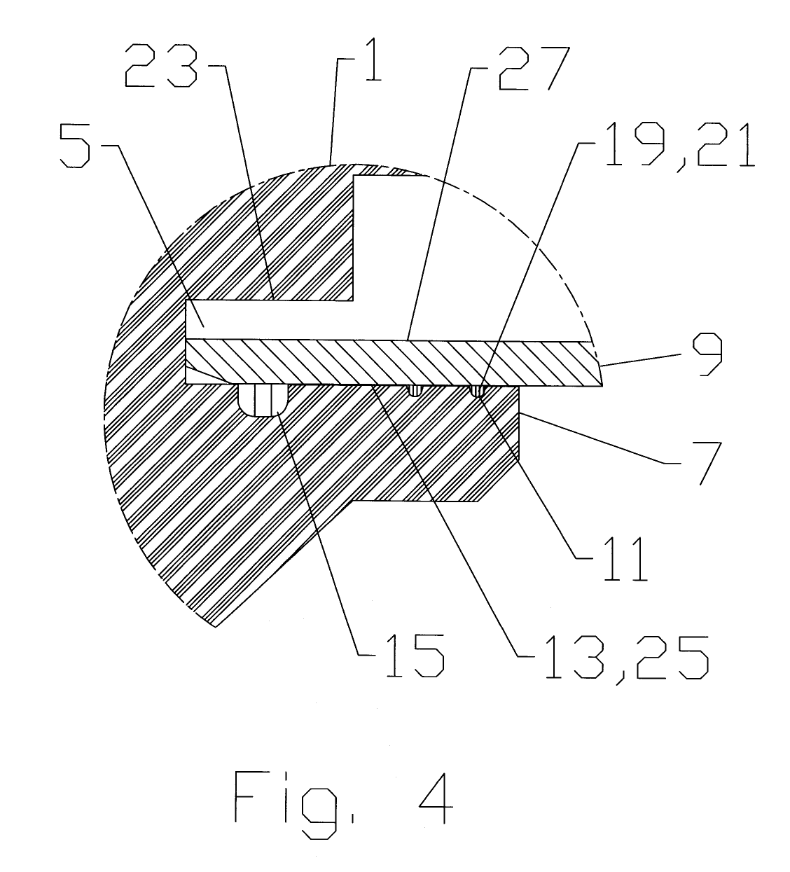

As shown for example in FIGS. 1-4, a monolithic cone 1 of polymeric material is dimensioned according to desired signal pattern and operating frequencies with a sub-reflector surface 3 formed, for example by the addition of a metallic layer or coating. An annular mating groove 5 of the cone 1 open to the cone bottom 7 is dimensioned to receive a distal end of the boom 9. At least one retention groove 11 is provided in an outer sidewall 13 of the mating groove 5. In the present embodiment, at least one gasket groove 15 is provided in the outer sidewall 13 of the mating groove 5, preferably above the at least one retention groove 11, with respect to the cone bottom 7. A gasket 17, for example an o-ring of a suitably resilient material such as rubber, silicone, EPDM, nitril, Buna-N or viton, is seated in the at least one gasket groove 15, sealing, in the present embodiment, between the outer sidewall 13 of the mating groove 5 and the distal end of the boom 9.

A glue 19 is applied between the boom 9 and the mating groove 5 either directly upon the retention groove(s) 11 and/or upon the boom 9 outer surface whereby as the distal end of the boom 9 is seated within the mating groove 5, the glue 19 is wiped along the boom 9, accumulating in the retention groove(s) 11. The glue 19 may be selected from a range of available glue(s) 19 with a suitable metal adhesion characteristic, to securely adhere the glue 19 to the metal material of the boom 9 as the glue 19 cures.

When cured, the glue 19 within the at least one retention groove 11 forms an annular retention lip 21, whereby even if a rigid glue 19 to polymeric cone 1 connection is not maintained over time, the glue 19 remains adhered at least to the boom 9, the retention lip 21 locked between the sidewalls of the at least one retention groove 11 mechanically retaining the cone 1 upon the distal end of the boom 9.

The glue 19 is preferably applied isolated from the at least one gasket groove 15, to allow the seal created by the gasket 17 seated therein to remain glue 19 free. In alternative embodiments, further separation between the gasket 17 and the area of glue 19 application may be obtained by locating the retention groove(s) 11 on an inner sidewall 23 of the mating groove 5 while the gasket groove 15 remains on the outer sidewall 13 or alternatively is formed in an outer surface 25 of the distal end of the boom 9. Alternatively, the gasket groove 15 may be formed on the inner sidewall 23 or inner surface 27 of the distal end of the boom 9, while the retention groove(s) 11 remain on the outer sidewall 23 of the mating groove 5.

The benefit of separation between the retention groove(s) 11 and gasket groove(s) 15 via separate placement along the inner sidewall 23 and/or outer sidewall 13 of the mating groove 5 and/or of the gasket groove 15 on inner and/or outer surfaces 25,27 of the boom 9 may be obtained in a tradeoff with electrical performance resulting from the respective groove(s) and/or gasket 17 contributing to the creation of an impedance discontinuity via their presence in the RF signal path through the boom 9.

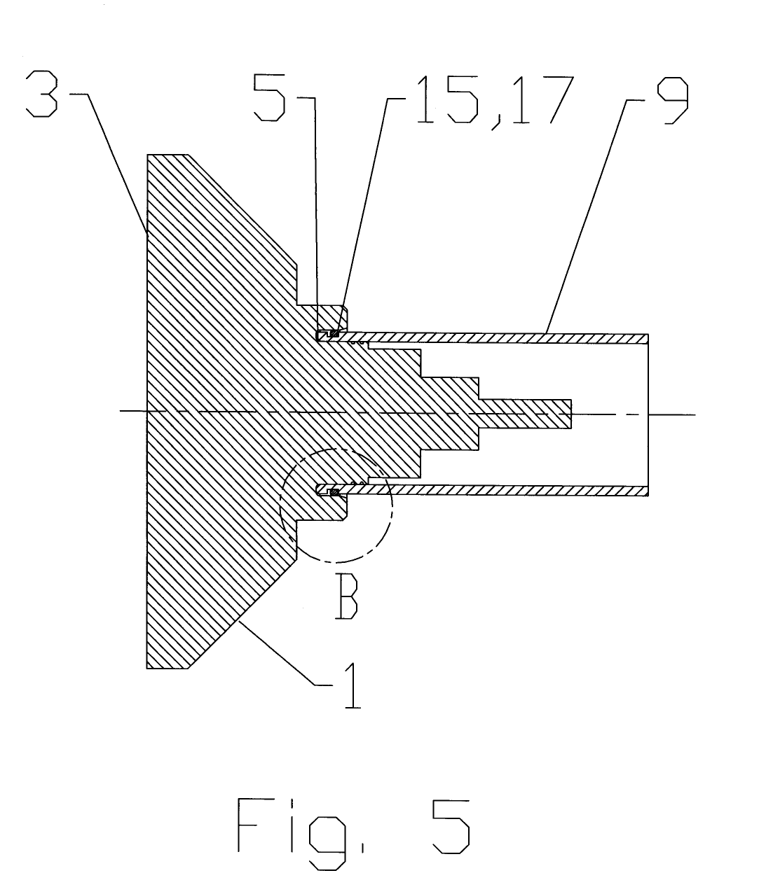

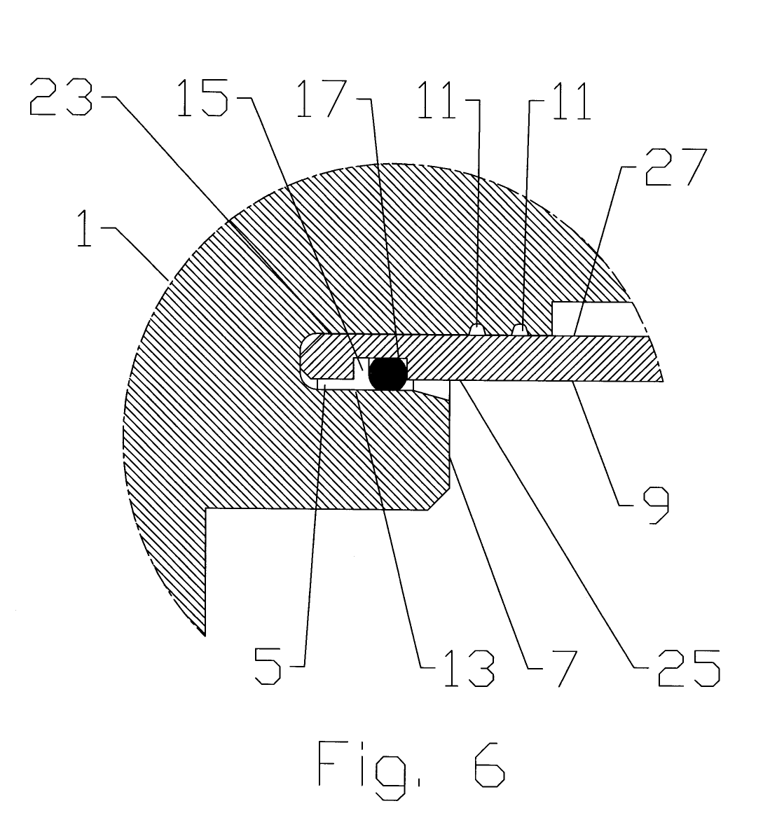

In further embodiments, the mechanical retention of the cone 1 upon the distal end of the boom 9 may be improved by forming the at least one retention groove 11 as multiple retaining groove(s) 11 either on the inner sidewall 23, for example as shown in FIGS. 5 and 6, on the outer sidewall 13 or both the inside and the outside sidewall(s) 13, 23. Similarly, the at least one gasket groove 15 may be formed as multiple gasket groove(s) 15 and corresponding gasket(s) 17 may also be applied to enhance the environmental seal between the open end of the boom 9 and the cone 1.

One skilled in the art will appreciate that the gasket 17 seated within the gasket groove 15 and the retaining lip 21 of cured glue 19 upon the metal boom 9, keyed between the sidewalls of the at least one retention groove 11 of the polymeric cone 1 may provide a secure mechanical interconnection with significant manufacturing and installation efficiencies compared to prior interconnections such as molded and/or machined threads. The interconnection may provide improved resistance to interconnection failure due to repeated thermal expansion and contraction resulting from installation in areas subject to extreme environmental conditions. Further, an interconnection according to the invention adds very little additional weight and/or volume to the cone 1 and boom 9 assembly, potentially reducing the feed assembly, reflector antenna and/or reflector antenna mounting structural requirements.

Table of Parts

| | |
|---|---|
| 1 | cone |
| 3 | sub-reflector surface |
| 5 | mating groove |
| 7 | cone bottom |
| 9 | boom |
| 11 | retention groove |
| 13 | outer sidewall |
| 15 | gasket groove |
| 17 | gasket |
| 19 | glue |
| 21 | retention lip |
| 23 | inner sidewall |
| 25 | outer surface |
| 27 | inner surface |

Where in the foregoing description reference has been made to materials, ratios, integers or components having known equivalents then such equivalents are herein incorporated as if individually set forth.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details, representative apparatus, methods, and illustrative examples shown and described. Accordingly, departures may be made from such details without departure from the spirit or scope of applicant's general inventive concept. Further, it is to be appreciated that improvements and/or modifications may be made thereto without departing from the scope or spirit of the present invention as defined by the following claims.

We claim:

1. A polymeric cone to metallic boom interconnection, comprising:
an annular mating groove of the cone dimensioned to receive a distal end of the boom;
at least one retention groove provided in a sidewall of the mating groove;
at least one gasket groove provided in the sidewall of the mating groove;
a gasket seated in the at least one gasket groove, sealing between the sidewall of the mating groove and the boom; and
a glue between the boom and the annular mating groove; the glue adhered to the boom as an annular retention lip within the at least one retention groove,
whereby the cone is mechanically retained upon the boom.

2. The interconnection of claim 1, wherein the glue is provided on an outer surface of the boom; the at least one retention groove formed on an outer sidewall of the annular mating groove.

3. The interconnection of claim 1, wherein the glue is provided on an inner surface of the boom; the at least one retention groove provided on an inner sidewall of the annular mating groove.

4. The interconnection of claim 1, wherein the glue is provided on an inner surface of the boom and on an outer surface of the boom; the at least one retention groove provided on an inner sidewall and on an outer sidewall of the annular mating groove.

5. The interconnection of claim 1, wherein the at least one retention groove is provided above the at least one gasket groove along the sidewall.

6. The interconnection of claim 1, wherein no glue is provided proximate the gasket groove.

7. The interconnection of claim 1, wherein the at least one retention groove is provided on an inner sidewall of the annular mating groove and the at least one gasket groove is provided on an outer sidewall of the mating groove.

8. A polymeric cone to metallic boom interconnection, comprising:
an annular mating groove of the cone dimensioned to receive a distal end of the boom;
at least one retention groove provided in an inner sidewall of the mating groove;
at least one gasket groove provided in a distal end of the boom;
a gasket seated in the at least one gasket groove, sealing between the sidewall of the mating groove and the boom; and
a glue between the boom and the mating groove; the glue adhered to the boom as an annular retention lip within the at least one retention groove, whereby the cone is mechanically retained upon the boom.

9. The interconnection of claim 8, wherein at least one of the gasket groove(s) is located on an outer surface of the boom.

10. The interconnection of claim 8, wherein at least one of the gasket groove(s) is located on an inner surface of the boom.

11. The interconnection of claim 8, wherein at least one of the retention groove(s) is on an inside surface of the mating groove.

12. The interconnection of claim 8, wherein at least one of the retention groove(s) is on an outside surface of the mating groove.

13. A method for forming an interconnection between a polymeric cone and a metallic boom, comprising the steps of:
applying a glue to an annular mating groove of the cone or a distal end of the boom;
inserting a distal end of the boom into the cone;
at least one retention groove provided in at least an inner sidewall of the mating groove;
at least one gasket groove provided in the distal end of the boom;
a gasket seated in the at least one gasket groove, dimensioned to seal between the sidewall of the mating groove and the boom;
the glue adhering to the boom as an annular retention lip within the at least one retention groove, whereby the cone is mechanically retained upon the boom.

14. The method of claim 13, wherein the glue is applied to the at least one retention groove, the retention groove provided on an inner sidewall of the annular mating groove.

15. The method of claim 13, wherein the glue is applied to the at least one retention groove.

16. The interconnection of claim 13, wherein the glue is applied to the retention groove(s), the retention groove(s) provided on an inner sidewall and on an outer sidewall of the annular mating groove.

17. The interconnection of claim 13, wherein the at least one retention groove is provided above a position along the sidewall opposite the at least one gasket groove.

18. The interconnection of claim 13, wherein no glue is applied proximate the gasket groove.

19. The interconnection of claim 13, wherein the at least one retention groove is provided on an inner sidewall of the annular mating groove and the at least one gasket groove is provided on an outer surface of the boom.

20. The interconnection of claim 13, wherein the glue is provided on the boom proximate a position opposite the retention groove(s) when the boom is seated within the mating groove.
